(19) United States
(12) Patent Application Publication
(10) Pub. No.: US 2024/0037511 A1
(43) Pub. Date: Feb. 1, 2024

(54) In-Person Meeting Scheduling Using A Machine Learning Model To Predict Participant Preferences

(71) Applicant: Zoom Video Communications, Inc., San Jose, CA (US)

(72) Inventors: Carleigh Pereira Noble, Chicago, IL (US); Shane Paul Springer, Manchester, MI (US)

(21) Appl. No.: 17/877,752

(22) Filed: Jul. 29, 2022

(51) Int. Cl. G06Q 10/10; G06N 5/02

(52) U.S. Cl. CPC G06Q 10/1095; G06N 5/022

(57) ABSTRACT

A processing system may receive an input for scheduling an in-person meeting between meeting participants. The input may include an indication of the meeting participants. The processing system may use a machine learning model to predict preferences of one or more of the meeting participants for attending the physical meeting. The preferences may include a physical location and an availability. The machine learning model may be trained using historical information including a past physical location and a past availability of the one or more meeting participants. The processing system may determine scheduling information for the in-person meeting based on the input and the preferences. The scheduling information may include a time, a date, and a physical location for the in-person meeting. The processing system may transmit the scheduling information to a meeting participant.

### FIELD

This disclosure relates generally to scheduling and, more specifically, to in-person meeting scheduling using a machine learning model to predict participant preferences.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system for in-person meeting scheduling between participants using a machine learning model to predict participant preferences.

FIG. 5 is a block diagram of an example of a processing system executing meeting software to determine scheduling information for an in-person meeting.

FIG. 6 is an illustration of an example of a graphical user interface (GUI) providing scheduling information to meeting participants.

FIG. 7 is a block diagram of an example of a map indicating a physical location for an in-person meeting.

FIG. 8 is an illustration of an example of a GUI providing scheduling information with a change to meeting participants.

FIG. 9 is a flowchart of an example of a technique for in-person meeting scheduling between participants using a machine learning model to predict participant preferences.

FIG. 10 is a flowchart of an example of a technique for monitoring for updates affecting scheduling information.

### DETAILED DESCRIPTION OF THE DRAWINGS

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises systems, meaning that remote workers and those who are generally increasingly mobile may be unable to rely upon them. One type of system which addresses problems such as these includes a unified communications as a service (UCaaS) platform, which includes several communications services integrated over a network, such as the Internet, to deliver a complete communication experience regardless of physical location.

Individuals may use software such as the UCaaS platform to communicate and collaborate remotely with one another in virtual meetings (e.g., video conferencing). In some cases, there may be advantages for individuals to also communicate and collaborate with one another in-person, such as by physically meeting with one another at an office or school. Software scheduling tools, such as those of conventional software platforms, generally seek input from a user for specifying a location for the meeting. Such conventional tools may be inefficient to the extent that they rely on manual event creation and/or fail to perceive needs of the user. In some cases, there may be external conditions that are relevant to the meeting event that are not capable of evaluation by such conventional tools due to their technical and design limitations. For example, such conventional tools may not contemplate commute times or inclement weather, and may not contemplate physical space, equipment, or network availability considerations that may be relevant to determining a location for an in-person meeting. The conventional tools typically lack functionality for interfacing with external systems that provide this information for specifying a location for a meeting, instead featuring a manual text input option for a user to specify the location for the meeting. As a result, the conventional tools are limited to serving manual event creation without perceiving the needs of the user. Thus, such conventional tools may lack an understanding of preferences of users for an in-person location, based on these types of considerations (e.g., commute times or weather, or physical space, equipment, or network availability), beyond the input for a location as specified by the user.

Implementations of this disclosure address problems such as these by using meeting software for automatically determining scheduling information for an in-person meeting between meeting participants. A processing system may receive an input for scheduling the in-person meeting (e.g., a meeting request). For example, the input may include an indication of the meeting participants, an indication of equipment for the in-person meeting (e.g., a camera, microphone, speaker, computer with video conferencing software, input interface, output projector, wireless Internet access, or digital whiteboard), a duration for the in-person meeting (e.g., one hour), a date window for the in-person meeting (e.g., between a first day and a second day), and/or a time window for the in-person meeting (e.g., between a first time and a second time). The processing system may use a machine learning model to predict the preferences of one or more of the meeting participants for attending the in-person meeting. The preferences may include a participant's preferred physical location, preferred own availability, and/or preferred equipment for attending the in-person meeting. The machine learning model may be trained using historical information including a past physical location, a past availability, and/or past equipment of the one or more meeting participants for attending an in-person meeting. The processing system may determine scheduling information for the in-person meeting based on the input and the preferences. The scheduling information may include a time, a date, and a physical location (e.g., a convenient public or semi-private location such as a restaurant, a café, or a library, or a private location such as an office, classroom, or home) for the in-person meeting. The processing system may transmit the scheduling information to the meeting participants, such as by sending electronic mail (i.e., email) and/or push notifications.

In some implementations, the processing system, executing the meeting software, may use an application programming interface (API) to communicate with one or more servers to obtain traffic information, weather information, calendar information, geolocation information, and/or meeting resource information for the one or more meeting participants. The one or more servers may be implemented by one or more systems that are separate from the processing system executing the meeting software. For example, the one or more servers may be used to implement one or more third party systems external to a software platform (e.g., a UCaaS platform) that implements the processing system. In some such cases, where an API of such a third party system is exposed, the processing system can make calls to the API to request and receive relevant information, as described above. The processing system may determine the scheduling information based on the traffic information, weather information, calendar information, geolocation information, and/or meeting resource information. In some implementations, the processing system may communicate with one or more servers to reserve the equipment and/or the physical location (e.g., the convenient public, semi-private, or private location) in accordance with the time and/or the date for the in-person meeting. The processing system may send the scheduling information to the meeting participants, and in some cases, may send email and/or push notifications including changes to the scheduling information based on updates. As a result, the processing system may suggest, and in some cases may caution against, particular logistics for in-person meetings, thereby improving the ability of individuals to attend meetings in person.

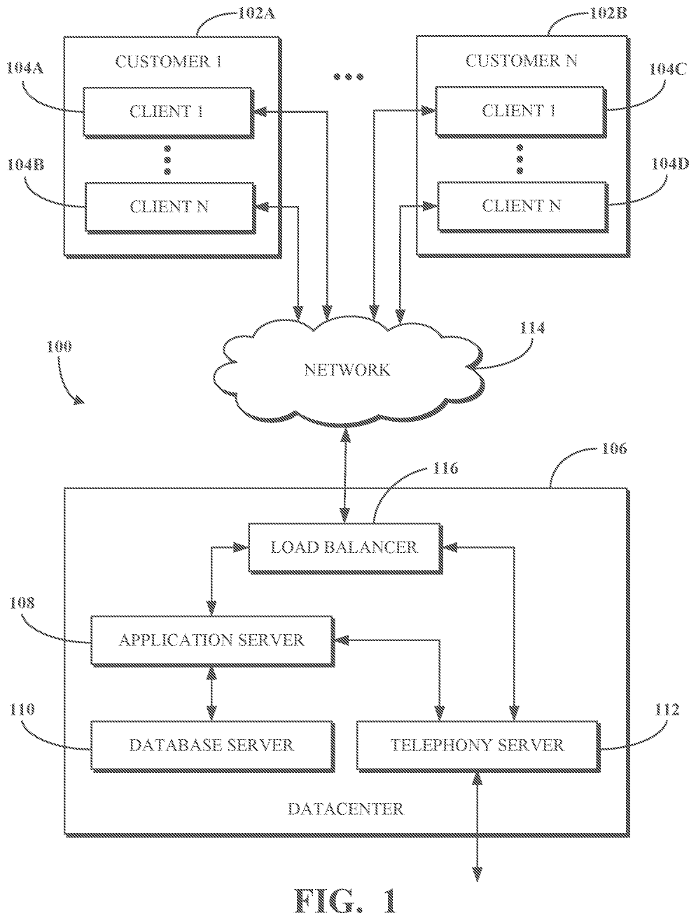

To describe some implementations in greater detail, reference is first made to examples of hardware and software structures used to implement a system for in-person meeting scheduling between participants using a machine learning model to predict participant preferences. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106. For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

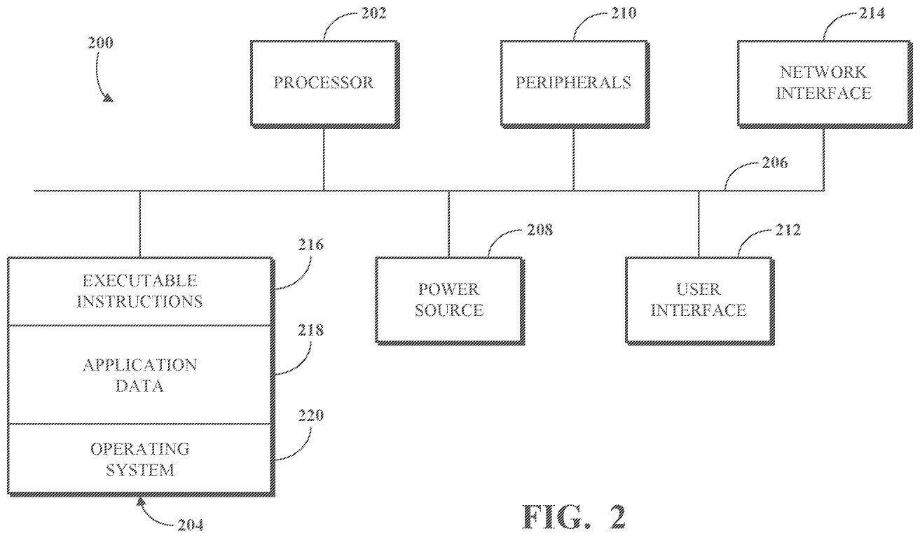

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR DRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, virtual reality display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

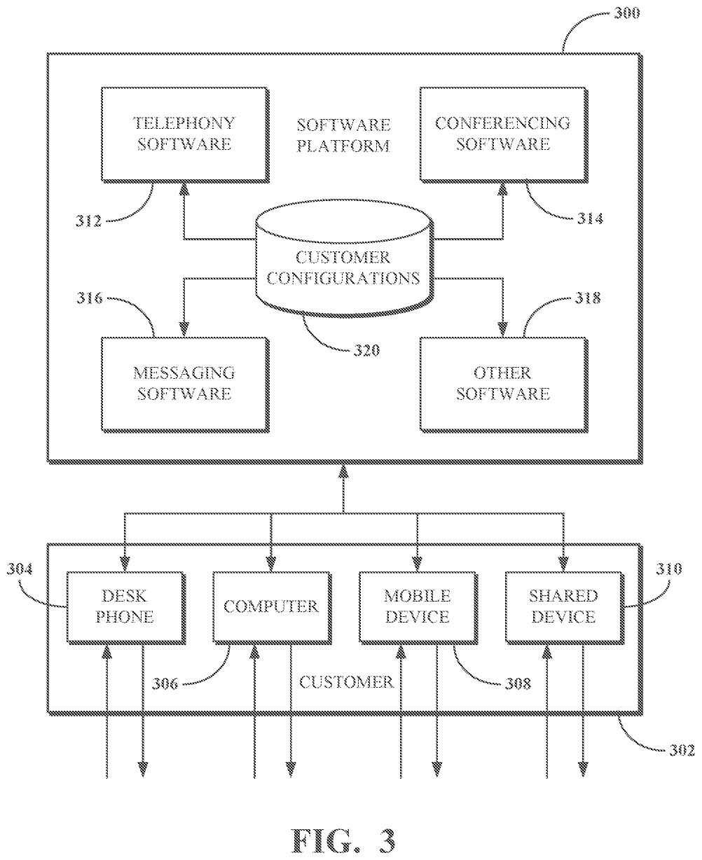

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include meeting software for in-person meeting scheduling between participants using a machine learning model to predict participant preferences. In some such cases, the conferencing software 314 may include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some, or all, of the software 312 through 318 may be combined into a single software application run on clients of the customer, such as one or more of the clients 304 through 310.

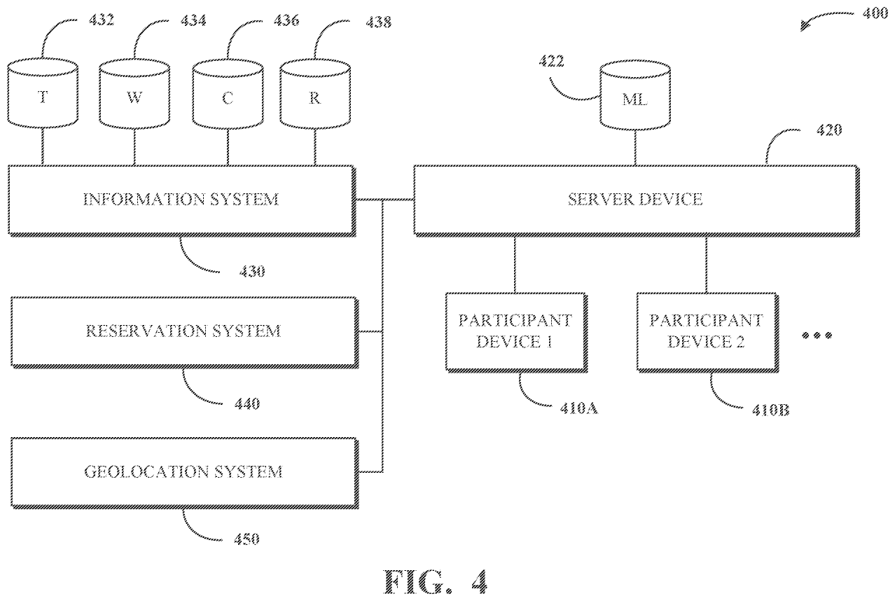

FIG. 4 is a block diagram of an example of a system 400 for in-person meeting scheduling between participants using a machine learning model to predict participant preferences. The system 400 may include one or more participant devices that can be used by the participants, such as participant devices 410A and 410B. For example, a participant device could be a client device such as one of the clients 104A through 104D shown in FIG. 1 or 304 through 310 shown in FIG. 3. Thus, a participant device may be a processing system that includes at least a processor and a memory. A participant device may execute software (e.g., client-side conferencing software, which could, for example, be via a client application or a web application used to connect to a conference implemented using server-side software, such as the conferencing software 314 shown in FIG. 3, and/or client-side meeting software, which could, for example, be used to determine or obtain scheduling information for an in-person meeting) and may connect to a server device 420. The server device 420 may execute software (e.g., server-side conferencing software, such as the conferencing software 314, to support a video conference between participants using the participant devices 410A and 410B, and/or server-side meeting software, such as the other software 318, for determining scheduling information for an in-person meeting between participants). For example, the server device 420 could be a server at the datacenter 106 shown in FIG. 1. Thus, the server device 420 may also be a processing system that includes at least a processor and a memory. Although two participant devices 410A and 410B are shown, other numbers of participant devices may be used in the system 400.

The conferencing software (e.g., the client-side conferencing software and/or the server-side conferencing software) may enable the participants to communicate and collaborate with one another in virtual meetings (e.g., video conferencing). The meeting software (e.g., the client-side meeting software and/or the server-side meeting software) may enable the participants to automatically determine scheduling information for an in-person meeting. A processing system, such as the server device 420, may receive an input for scheduling the in-person meeting. For example, the input may include an indication of one or more of the meeting participants (e.g., a first participant using the participant device 410A, and a second participant using the participant device 410B), an indication of equipment for the in-person meeting (e.g., a camera, microphone, speaker, computer with video conferencing software, input interface, output projector, wireless Internet access, or digital whiteboard), a duration for the in-person meeting (e.g., one hour), a date window for the in-person meeting (e.g., between a first day and a second day), and/or a time window for the in-person meeting (e.g., between a first time and a second time). The processing system may use a machine learning model to predict the preferences of the one or more meeting participants for attending the in-person meeting. For example, the server device 420 may use a machine learning model stored in the data structure 422. The server device 420 may use the machine learning model to predict the preferences of the one or more participants, such as the first participant (e.g., the meeting requester) and the second participant (e.g., a meeting recipient or invitee). The preferences may include a participant's preferred physical location, a participant's preferred own availability (e.g., a time and/or a date), and/or a participant's preferences preferred equipment for attending the in-person meeting. For example, the machine learning model may be used to predict that the first participant prefers a public location, such as a café, on weekday mornings, and prefers a high availability wireless Internet connection, and that the second participant prefers a private location, such as an office, all day on Mondays through Thursday, and a public location, such as a café, on Fridays.

To make the predictions, the machine learning model may be trained using historical information, including past physical locations, past availabilities, and/or past equipment used by the meeting participants (e.g., the first participant and the second participant). For example, the machine learning model can be trained using a training data set including data samples representing parameters for historical meetings, including physical locations, availabilities, and equipment. The training data set can enable the machine learning model to learn patterns, such as physical locations, co-participants, dates, times, subject matter, and equipment. The training can be periodic, such as by updating the machine learning model on a discrete time interval basis (e.g., once per week or month), or otherwise. The training data set may derive from multiple participants (e.g., the first participant and the second participant) or may be specific to a particular participant (e.g., an in-person meeting requester, such as the first participant, or an in-person meeting invitee, such as the second participant). The training data set may omit certain data samples that are determined to be outliers, such as based on in-person meetings actually occurring other than at the scheduled locations (e.g., as determined using geolocations of devices detected at meeting times being different from those scheduled locations). The machine learning model may, for example, be or include one or more of a neural network (e.g., a convolutional neural network, recurrent neural network, deep neural network, or other neural network), decision tree, vector machine, Bayesian network, cluster-based system, genetic algorithm, deep learning system separate from a neural network, or other machine learning model.

The processing system may use the machine learning model to determine scheduling information for the in-person meeting based on the input and the preferences. The scheduling information can be determined based on having highest probability for satisfying the input (e.g., the meeting request). The scheduling information may include a time, a date, and a physical location (e.g., a convenient public or semi-private location such as a restaurant, a café, or a library, or a private location such as an office, classroom, or home) for the in-person meeting. For example, the processing system may determine that a given public location, such as the café, which offers high availability wireless Internet connections, at a given time and date, such as a next occurring Friday morning, would have the highest probability for satisfying the input submitted by the first participant. The processing system can then transmit the scheduling information to the participants, such as by sending emails and/or push notifications to the participant devices (e.g., the participant devices 410A and 410B).

In some implementations, the processing system may communicate with one or more servers, via an API, to obtain traffic information, weather information, calendar information for meeting participants, and/or meeting resource information. The one or more servers may be implemented by one or more systems that are separate from the processing system that is executing the meeting software. For example, the server device 420, executing the meeting software, may use an API to communicate with an information system 430 to access traffic information from a traffic system 432, weather information from a weather system 434, calendar information from a calendar system 436, and/or meeting resource information from a meeting resource system 438. The processing system may determine the scheduling information based on the traffic information, the weather information, the calendar information, and/or the meeting resource information.

In some implementations, the processing system may communicate with one or more servers, via an API, to determine reservation information, such as availability of a physical location, and/or to reserve the physical location (e.g., the convenient public, semi-private, or private location) in accordance with the time and/or the date for the meeting. For example, the server device 420 may communicate with a reservation system 440 to access the reservation information, such as availability of a table at a restaurant or an office at a shared office location. The processing system may determine the scheduling information based on the availability, and may communicate with the reservation system 440 to reserve the physical location (e.g., reserve the table or the office) in accordance with the time and/or the date.

In some implementations, the processing system may communicate with a geolocation system to obtain geolocation information for one or more of the meeting participants. For example, the server device 420 may communicate with a geolocation system 450 to access a geolocation of a participant. The processing system may determine the scheduling information based on the geolocation of the participants. In some cases, the processing system may change the scheduling information based on geolocation, such as when the processing system determines that a participant is in a condition in which the participant will miss the in-person meeting (e.g., the participant is more than one hour away from a physical location where a meeting is scheduled to begin in less than one hour). As a result, the processing system may suggest, and in some cases may caution against, particular logistics for in-person meetings, thereby improving the ability of individuals to attend meetings in person.

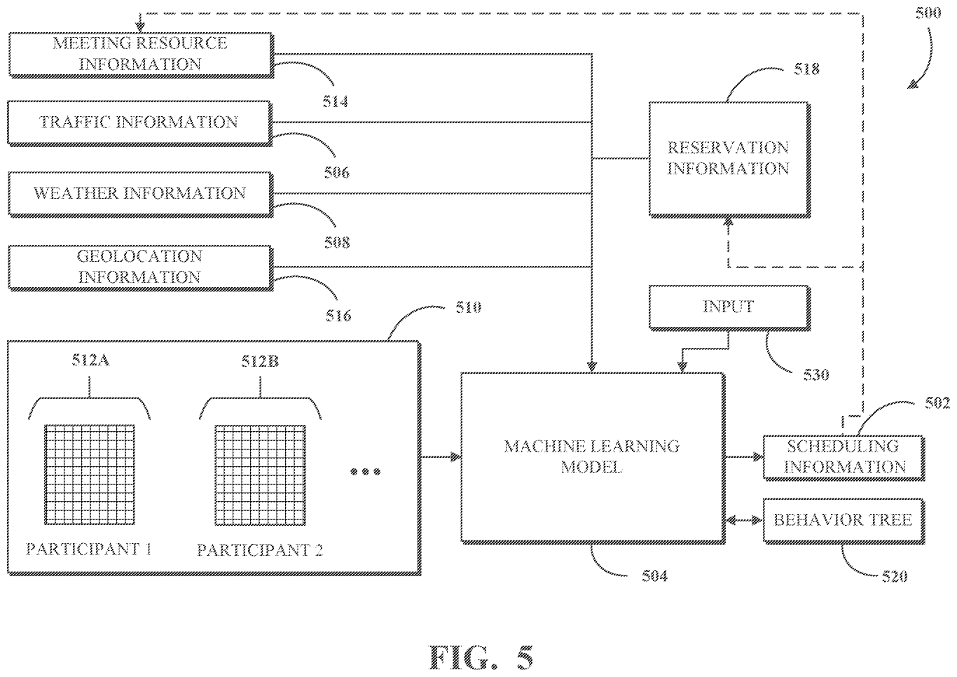

FIG. 5 is a block diagram of an example of a processing system 500 executing meeting software for determining scheduling information 502 for an in-person meeting. The processing system 500 may receive an input 530 for scheduling the in-person meeting (e.g., an indication of meeting participants, an indication of equipment for the in-person meeting, a duration for the in-person meeting, a date window for the in-person meeting, and/or a time window for the in-person meeting). The processing system 500 may include a machine learning model 504 (e.g., the machine learning model stored in the data structure 422 in FIG. 4). The machine learning model 504 may receive the input 530. The machine learning model 504 may predict preferences of participants for attending the in-person meeting, as specified by the input 530, for determining the scheduling information 502.

The machine learning model 504 may receive traffic information 506 from a system like the traffic system 432. The traffic information 506 may include mapping and traffic conditions for determining possible travel routes for participants to attend an in-person meeting on time, with distributed effort (e.g., closely matching the travel times for the various participants). For example, the processing system may select a physical location, time, and/or day so that participants do not experience a disproportionate increase in difficulty attending the meeting due to a travel condition. The traffic information 506 may include past (e.g., historic) traffic information and future (e.g., predicted) traffic information. The processing system may train the machine learning model 504 based on the traffic information 506, and may use the machine learning model 504, based on the training, for example, to predict the movement and/or preferences of participants for determining the scheduling information 502.

The machine learning model 504 may receive weather information 508 from a system like the weather system 434. The weather information 508 may include mapping and weather conditions for determining the ability of participants to attend an in-person meeting on time, with distributed effort (e.g., closely matching the travel conditions for the various participants). For example, the processing system may select a physical location, time, and/or day so that participants do not experience a disproportionate increase in difficulty attending the meeting due to a weather condition. The weather information 508 may include past (e.g., historic) weather information and future (e.g., predicted) weather information. The processing system may train the machine learning model 504 based on the weather information 508, and may use the machine learning model 504, based on the training, to predict the movement and/or preferences of participants for determining the scheduling information 502.

The machine learning model 504 may receive calendar information 510 from a system like the calendar system 436. The calendar information 510 may include past (e.g., historic) calendar events and future (e.g., predicted) calendar events for the one or more participants. For example, the calendar information 510 may include past calendar events and future calendar events 512A for the first participant (e.g., using the participant device 410A) and past calendar events and future calendar events 512B for the second participant (e.g., using the participant device 410B). The past calendar events may include past physical locations of meetings, past availabilities of the participant for attending those meetings, and/or past equipment used by the participant at those meetings. The processing system may train the machine learning model 504 based on the calendar information 510, and may use the machine learning model 504, based on the training, for example, to predict the movement and/or preferences of participants for determining the scheduling information 502.

The machine learning model 504 may receive meeting resource information 514 from a system like the meeting resource system 438. The meeting resource information 514 may include past (e.g., historic) availability of equipment for an in-person meeting and future (e.g., predicted) availability of equipment for an in-person meeting. The equipment may include, for example, a camera, microphone, speaker, computer with video conferencing software, input interface, output projector, wireless Internet access, or digital whiteboard. The processing system may train the machine learning model 504 based on the meeting resource information 514, and may use the machine learning model 504, based on the training, for example, to predict the movement and/or preferences of participants for determining the scheduling information 502. In some implementations, the processing system may apply the scheduling information 502 by reserving the equipment and updating the meeting resource information 514.

The machine learning model 504 may receive reservation information 518 from a system like the reservation system 440. The reservation information 518 may include availability of a physical location at a time and date for the in-person meeting. For example, the reservation information 518 may include availability of a table at a restaurant, or availability of an office at a shared office location. The processing system may train the machine learning model 504 based on the reservation information 518, and may use the machine learning model 504, based on the training, for example, to predict the movement and/or preferences of participants for determining the scheduling information 502. In some implementations, the processing system may apply the scheduling information 502 by reserving the physical location (e.g., reserve the table or the office) in accordance with the time and/or the date, and updating the reservation information 518.

The machine learning model 504 may receive geolocation information 516 from a system like the geolocation system 450. The geolocation information 516 could be implemented, for example, by a global positioning system (GPS) in a participant device (e.g., the participant device 410A or 410B). The processing system may determine the scheduling information 502 based on the geolocation of one or more of the participants. In some implementations, the processing system may train the machine learning model 504 based on the geolocation information 516, and may use the machine learning model 504, based on the training, for example, to predict the movement and/or preferences of participants for determining the scheduling information 502.

The processing system may train the machine learning model 504 based on one or more of the aforementioned training information. For example, the machine learning model 504 may be trained based on a combination of two or more of the traffic information 506, the weather information 508, the calendar information 510, the meeting resource information 514, the geolocation information 516, and the reservation information 518.

In some cases, the processing system may use the machine learning model 504 to predict that a participant will miss the in-person meeting. The prediction may be made based on a combination of information, such as the traffic information 506, the weather information 508, the meeting resource information 514, the geolocation information 516, and/or the reservation information 518. When the processing system determines that a participant is in a condition in which the participant will miss the meeting, the processing system may change the scheduling information 502. For example, the processing system may change the scheduling information 502 based on the geolocation information 516, such as when the processing system determines that a geolocation of a participant will cause the participant to miss the meeting (e.g., the participant is more than one hour away from the location where a meeting is scheduled to begin in less than one hour). In such cases, the processing system may update the scheduling information 502, and may send notifications (e.g., push notifications) to the participants indicating the change. In some implementations, the processing system may propose the change to the meeting participants before changing the scheduling information. In some implementations, the change may include canceling the in-person meeting at the physical location and arranging, as an alternative, a virtual meeting between the participants (e.g., a video conference).

In some implementations, the processing system may execute the meeting software to build a behavior tree 520 that may be stored in a data structure (e.g., the data structure 422). The behavior tree 520 could be built, for example, based on feedback from multiple participants of in-person meetings. The behavior tree 520 could implement a mathematical model used by the meeting software. The behavior tree 520 could include a representation of requirements used to determine scheduling information with a highest probability for satisfying the input 530 (e.g., a meeting request). In some cases, the machine learning model 504 may update the behavior tree 520, such as by including past (e.g., historic) traffic information, weather information, calendar information, meeting resource information, geolocation information, and/or reservation information, as described herein. In some cases, the machine learning model 504 may use the behavior tree 520, for example, when predicting the preferences of participants for determining the scheduling information 502.

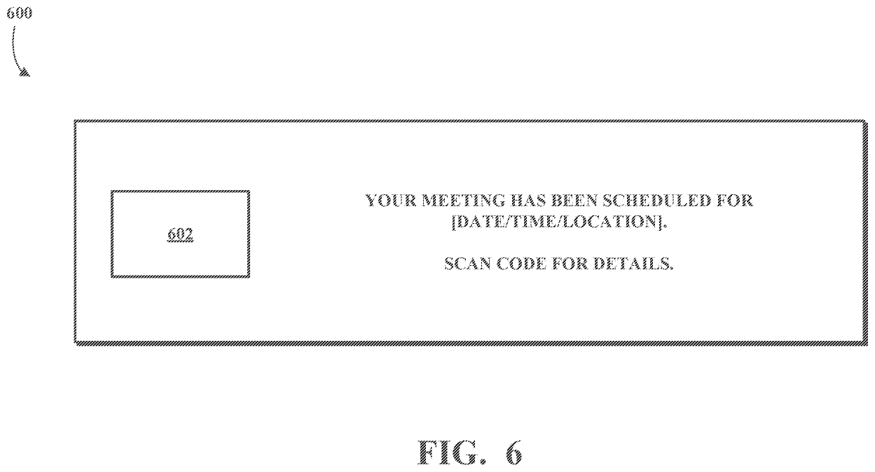

FIG. 6 is an illustration of an example of a GUI 600 providing scheduling information to meeting participants. The GUI 600 could be output for display at an output interface like the user interface 212 shown in FIG. 2. The GUI 600 could be displayed by a processing system like the participant device 410A or the participant device 410B shown in FIG. 4. The GUI 600 could be conveyed, for example, in connection with an email, voicemail (e.g., transcribed), text message, instant message, chat message, or push notification delivered through a communications network.

The GUI 600 may be generated in response to determining scheduling information (e.g., the scheduling information 502) for an in-person meeting. The GUI 600 may be used to transmit the scheduling information to meeting participants. For example, the server device 420, shown in FIG. 4, could cause the GUI 600 to be displayed to the participant device 410A and/or the participant device 410B to notify the first participant and/or the second participant of the scheduling information. The scheduling information may include a time, a date, and a physical location for the meeting. The GUI 600 may also include an indicium 602, such as quick response (QR) code or uniform resource locator (URL) link, to permit participants to obtain detailed information about the scheduling information (e.g., directions, traffic conditions, weather reports, restaurant menus, customer reviews, and equipment details, such as login credentials or wireless Internet access information). For example, a participant may scan the QR code or select the URL link to obtain a detailed report of the scheduling information.

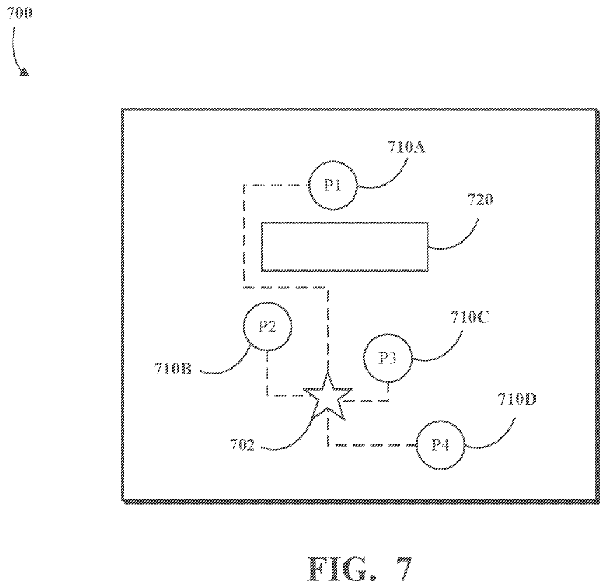

In some cases, the processing system (e.g., the server device 420, executing the meeting software) may monitor for updates affecting the scheduling information (e.g., the scheduling information 502), and in such cases, may notify participants, and/or change the scheduling information, based on the updates. For example, FIG. 7 is a block diagram of a map 700 indicating a physical location 702 for an in-person meeting that has been scheduled. The map 700 could be accessed, for example, via the traffic system 432, the weather system 434, the calendar system 436, and/or the meeting resource system 438. The processing system could determine, periodically, the geolocations of one or more of the meeting participants scheduled to attend the meeting, such as participants 710A through 710D (e.g., P1 through P4). Based on the monitoring, the processing system may receive an update that a participant is in a condition in which the participant will miss the meeting. For example, the update may include a traffic or weather condition 720 that has developed, which will affect the ability of a participant (e.g., the participant 710A) to be on time for the meeting (e.g., the meeting may be scheduled to begin in less than one hour, and the participant 710A may be more than one hour away from physical location 702 due to the traffic or weather condition 720). In such cases, the processing system may update the scheduling information, and may send notifications (e.g., push notifications) to the participants indicating the change. In some implementations, the processing system may propose the change to meeting participants before changing the scheduling information (e.g., a participant may approve a proposed change before the proposed change is implemented). In some implementations, the processing system may cancel the in-person meeting at the physical location 702 and arrange, as an alternative, a virtual meeting between the participants (e.g., a video conference).

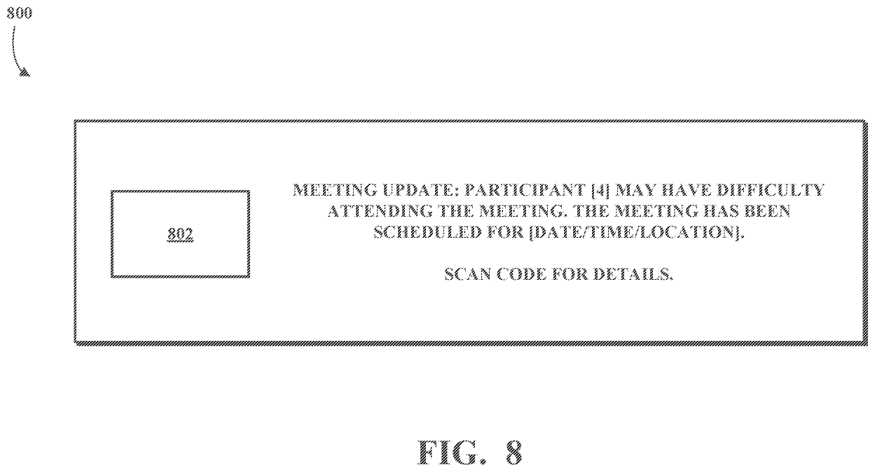

FIG. 8 is an illustration of an example of a GUI 800 providing scheduling information with a change to meeting participants. The GUI 800 could be output for display at an output interface like the user interface 212 shown in FIG. 2. The GUI 800 could be displayed by a processing system like the participant device 410A or the participant device 410B shown in FIG. 4. The GUI 800 could be conveyed, for example, in connection with an email, voicemail (e.g., transcribed), text message, instant message, chat message, or push notification delivered through a communications network.

The GUI 800 may be generated in response to a processing system determining a change to scheduling information (e.g., the scheduling information 502) for an in-person meeting. The GUI 600 may be used to transmit the change in the scheduling information to the meeting participants. For example, the server device 420, shown in FIG. 4, could cause the GUI 800 to be displayed to the participant device 410A and/or the participant device 410B to notify the first participant and/or the second participant of changes to the scheduling information. The changes may include a change to the time, the date, and/or the physical location for the meeting, or conversion of the in-person meeting to a virtual meeting. The GUI 800 may also include an indicium 802, such as QR code or URL link, to permit participants to obtain detailed information about the change to the scheduling information (e.g., changes to directions, traffic conditions, weather reports, restaurant menus, customer reviews, and equipment details, such as login credentials or wireless Internet access information). For example, a participant may scan the QR code or select the URL link to obtain a detailed report of the scheduling information, including with changes based on updates.

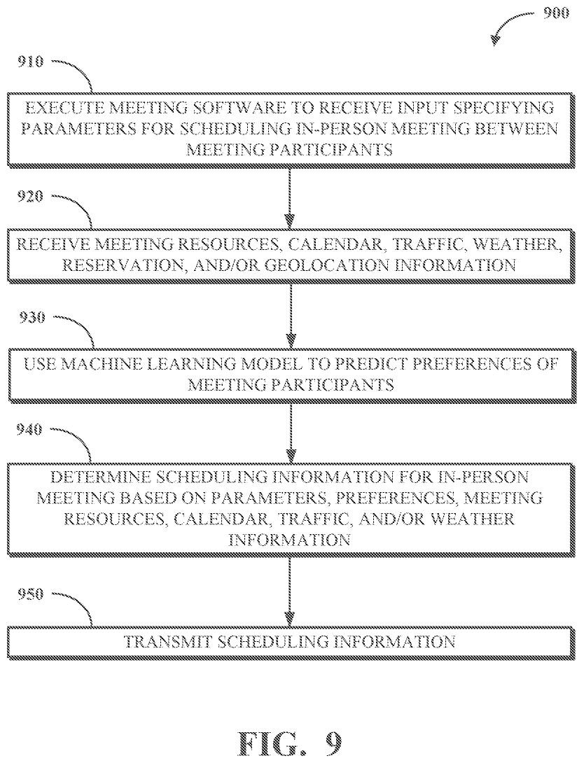

To further describe some implementations in greater detail, reference is next made to examples of techniques which may be performed by or using a system for in-person meeting scheduling between participants using a machine learning model to predict participant preferences. FIG. 9 is a flowchart of an example of a technique 900 for determining scheduling information. The technique 900 can be executed using computing devices, such as the systems, hardware, and software described with respect to FIGS. 1-8. The technique 900 can be performed, for example, by executing a machine-readable program or other computer-executable instructions, such as routines, instructions, programs, or other code. The steps, or operations, of the technique 900 or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 910, a processing system (e.g., the participant device 410A, the participant device 410B, or the server device 420) may execute meeting software to receive an input for scheduling an in-person meeting between meeting participants. For example, the input may include an indication of the meeting participants, an indication of equipment for the in-person meeting (e.g., a camera, microphone, speaker, computer with video conferencing software, input interface, output projector, wireless Internet access, or digital whiteboard), a duration for the in-person meeting (e.g., one hour), a date window for the in-person meeting (e.g., between a first day and a second day), and/or a time window for the in-person meeting (e.g., between a first time and a second time).

At 920, the processing system may obtain traffic information, weather information, calendar information, meeting resource information, reservation information, and/or geolocation information for determining scheduling information (e.g., the scheduling information 502). For example, the processing system may communicate with an information system (e.g., the information system 430) to access traffic information from a traffic system 432 (e.g., the traffic system 432), weather information from a weather system 434 (e.g., the weather system 434), calendar information from a calendar system 436 (e.g., the calendar system 436), and/or meeting resource information from a meeting resource system (e.g., the meeting resource system 438). The processing system may also communicate with a geolocation system (e.g., the geolocation system 450) to access a geolocation of one or more of the participants. The processing system may also communicate with a reservation system (e.g., reservation system 440) to access availability information, such as availability of a table at a restaurant or an office at a shared office location.

At 930, the processing system may use a machine learning model (e.g., the machine learning model 504) to predict the preferences of one or more of the meeting participants for attending the in-person meeting. The machine learning model may be trained using historical information, including past physical locations, past availabilities, and/or past equipment used by the meeting participants (e.g., the first participant and the second participant). The machine learning model may, for example, be or include one or more of a neural network (e.g., a convolutional neural network, recurrent neural network, deep neural network, or other neural network), decision tree, vector machine, Bayesian network, cluster-based system, genetic algorithm, deep learning system separate from a neural network, or other machine learning model. The preferences predicted by the machine learning model may include a physical location, an availability, and/or equipment for attending the in-person meeting. The machine learning model may be trained based on received information. Thus, the preferences may be predicted based on a combination of information, such as traffic information (e.g., the traffic information 506), weather information (e.g., the weather information 508), calendar information (e.g., the calendar information 510), meeting resource information (e.g., the meeting resource information 514), geolocation information (e.g., the geolocation information 516), and/or reservation information (e.g., the reservation information 518). In some implementations, the processing system may build a behavior tree (e.g., the behavior tree 520), based on feedback from participants of in-person meetings, and the machine learning model may use the behavior tree to predict the preferences.

At 940, the processing system may determine scheduling information for the in-person meeting based on the input and the preferences. The scheduling information may include a time, a date, and a physical location (e.g., a convenient public or semi-private location such as a restaurant, a café, or a library, or a private location such as an office, classroom, or home) for the in-person meeting. The processing system may apply the scheduling information by reserving the equipment and updating the meeting resource information. The processing system may also apply the scheduling information by reserving the physical location (e.g., reserve the table or the office) in accordance with the time and/or the date, and updating the reservation information.

At 950, the processing system may transmit the scheduling information to the meeting participants. For example, the processing system may send emails and/or push notifications to the participants via the participant devices (e.g., the participant devices 410A and 410B). In some implementations, the processing system may cause display of a GUI to the participant devices, such as the GUI 600, indicating the scheduling information.

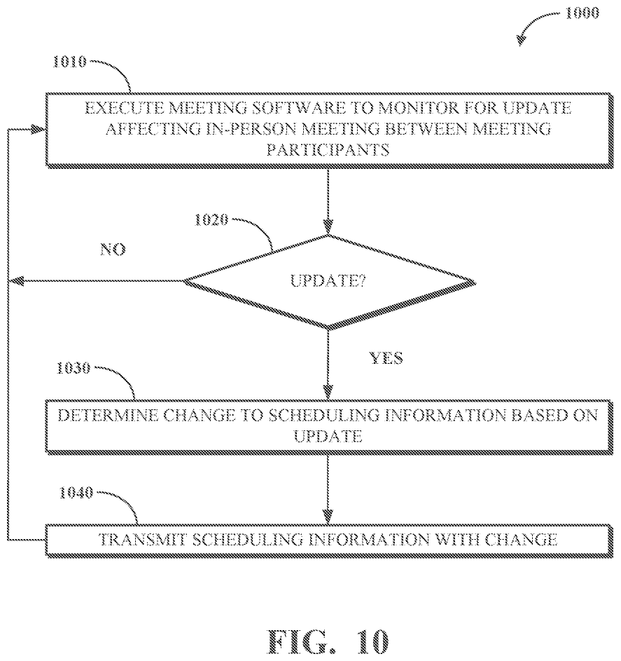

FIG. 10 is a flowchart of an example of a technique 1000 for monitoring for updates affecting scheduling information. The technique 1000 can be executed using computing devices, such as the systems, hardware, and software described with respect to FIGS. 1-8. The technique 1000 can be performed, for example, by executing a machine-readable program or other computer-executable instructions, such as routines, instructions, programs, or other code. The steps, or operations, of the technique 1000 or another technique, method, process, or algorithm described in connection with the implementations disclosed herein can be implemented directly in hardware, firmware, software executed by hardware, circuitry, or a combination thereof.

For simplicity of explanation, the technique 1000 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1010, a processing system (e.g., the participant device 410A, the participant device 410B, or the server device 420) may execute meeting software to monitor for updates affecting scheduling information (e.g., the scheduling information 502). The scheduling information may include a time, a date, and a physical location for an in-person meeting. The processing system may obtain traffic information, weather information, calendar information, meeting resource information, reservation information, and/or geolocation information to monitor for updates affecting scheduling information. For example, the processing system may communicate with an information system (e.g., the information system 430) to access traffic information from a traffic system 432 (e.g., the traffic system 432), weather information from a weather system 434 (e.g., the weather system 434), calendar information from a calendar system 436 (e.g., the calendar system 436), and/or meeting resource information from a meeting resource system (e.g., the meeting resource system 438). The processing system may also communicate with a geolocation system (e.g., the geolocation system 450) to access a geolocation of one or more of the participants. The processing system may also communicate with a reservation system (e.g., reservation system 440) to access availability information, such as availability of a table at a restaurant or an office at a shared office location. The processing system may monitor for updates in the information periodically. In some implementations, the processing system may monitor for updates in the information based on an inquiry from a participant.

At 1020, the processing system may determine whether there is an update affecting scheduling information. For example, the update may include a traffic or weather condition (e.g., the traffic or weather condition 720) that has developed, which the processing system predicts will affect the ability of a participant to attend the meeting. If there is no update affecting scheduling information (“No”), the processing system may continue to monitor for updates affecting the scheduling information at 1010. However, if there is an update affecting scheduling information (“Yes”), the processing system may determine a change to the scheduling information, based on the update, at 1030. The processing system may apply the change to the scheduling information and/or the reservation information, such as by changing a reservation for the time, the date, and/or the physical location. The processing system may also apply the change to the scheduling information by changing a reservation for the equipment and updating the meeting resource information. In some implementations, the processing system may propose the change to meeting participants before changing the scheduling information. In some implementations, the change may include canceling the in-person meeting at the physical location and arranging, as an alternative, a virtual meeting between the participants (e.g., a video conference).

At 1050, the processing system may send notifications (e.g., push notifications) to the participants indicating the change. For example, the processing system may send emails and/or push notifications to the participants via the participant devices (e.g., the participant devices 410A and 410B). In some implementations, the processing system may cause display of a GUI to the participant devices, such as the GUI 800, indicating the change to the scheduling information. The processing system may then continue to monitor for additional updates that may affect the scheduling information at 1010 (e.g., another change to the scheduling information).

Some implementations may include a method, including: receiving, by a processing system, an input for scheduling an in-person meeting between meeting participants, wherein the input includes an indication of the meeting participants; using, by the processing system, a machine learning model to predict preferences of one or more of the meeting participants for attending the in-person meeting, wherein the preferences include a physical location and an availability, and wherein the machine learning model is trained using historical information including a past physical location and a past availability of the one or more meeting participants; determining, by the processing system, scheduling information for the in-person meeting based on the input and the preferences, wherein the scheduling information includes a time, a date, and a physical location for the in-person meeting; and transmitting, by the processing system, the scheduling information to a meeting participant. In some implementations, the method may include communicating, by the processing system, with one or more servers to obtain traffic information, weather information, and calendar information for a meeting participant; predicting, by the processing system, movement of the meeting participant based on the traffic information, the weather information, and the calendar information; and determining, by the processing system, the scheduling information based on the movement. In some implementations, the method may include communicating, by the processing system, with one or more servers, via an API, to reserve the physical location in accordance with the time and the date for the in-person meeting. In some implementations, the method may include communicating, by the processing system, with one or more servers, via an API, to obtain a geolocation of a meeting participant; and changing, by the processing system, the scheduling information based on the geolocation. In some implementations, the method may include receiving, by the processing system, an update indicating a meeting participant will miss the in-person meeting; and changing, by the processing system, the scheduling information to cancel the in-person meeting at the physical location and to arrange a virtual meeting. In some implementations, the method may include receiving, by the processing system, an update indicating a meeting participant will miss the in-person meeting; changing, by the processing system, the scheduling information based on the update; and sending, by the processing system, a push notification, to the meeting participant, including the scheduling information with the change based on the update. In some implementations, the method may include receiving, by the processing system, feedback from a meeting participant; and building, by the processing system, a behavior tree based on the feedback, wherein the behavior tree is used by the machine learning model to determine other scheduling information for a second in-person meeting. In some implementations, the input further includes an indication of equipment for the in-person meeting, a duration for the in-person meeting, and at least one of a date window or a time window for the in-person meeting.

Some implementations may include an apparatus, including: a memory; and a processor configured to execute instructions stored in the memory to: receive an input for scheduling an in-person meeting between meeting participants, wherein the input includes an indication of the meeting participants; use a machine learning model to predict preferences of one or more of the meeting participants for attending the in-person meeting, wherein the preferences include a physical location and an availability, and wherein the machine learning model is trained using historical information including a past physical location and a past availability of the one or more meeting participants; determine scheduling information for the in-person meeting based on the input and the preferences, wherein the scheduling information includes a time, a date, and a physical location for the in-person meeting; and transmit the scheduling information to a meeting participant. In some implementations, the processor is further configured to execute instructions stored in the memory to: communicate with one or more servers to obtain traffic information, weather information, and calendar information for a meeting participant; predict movement of the meeting participant based on the traffic information, the weather information, and the calendar information; and determine the scheduling information based on the movement. In some implementations, the processor is further configured to execute instructions stored in the memory to: communicate with one or more servers, via an API, to reserve the physical location in accordance with the time and the date for the in-person meeting. In some implementations, the processor is further configured to execute instructions stored in the memory to: communicate with one or more servers, via an API, to obtain a geolocation of a meeting participant; and change the scheduling information based on the geolocation. In some implementations, the processor is further configured to execute instructions stored in the memory to: receive an update indicating a meeting participant will miss the in-person meeting; and change the scheduling information to cancel the in-person meeting at the physical location and to arrange a virtual meeting. In some implementations, the processor is further configured to execute instructions stored in the memory to: receive an update indicating a meeting participant will miss the in-person meeting; change the scheduling information based on the update; and send a push notification, to the meeting participant, including the change based on the update. In some implementations, the processor is further configured to execute instructions stored in the memory to: receive feedback from a meeting participant; and build a behavior tree based on the feedback, wherein the behavior tree is used by the machine learning model to determine other scheduling information for a second in-person meeting.

Some implementations may include a non-transitory computer readable medium storing instructions operable to cause one or more processors to perform operations including: receiving an input for scheduling an in-person meeting between meeting participants, wherein the input includes an indication of the meeting participants; using a machine learning model to predict preferences of one or more of the meeting participants for attending the in-person meeting, wherein the preferences include a physical location and an availability, and wherein the machine learning model is trained using historical information including a past physical location and a past availability of the one or more meeting participants; determining scheduling information for the in-person meeting based on the input and the preferences, wherein the scheduling information includes a time, a date, and a physical location for the in-person meeting; and transmitting the scheduling information to a meeting participant. In some implementations, the operations further include communicating with one or more servers to obtain traffic information, weather information, and calendar information for a meeting participant; predicting movement of the meeting participant based on the traffic information, the weather information, and the calendar information; and determining the scheduling information based on the movement. In some implementations, the operations further include communicating with one or more servers, via an API, to reserve the physical location in accordance with the time and the date for the in-person meeting. In some implementations, the operations further include communicating with one or more servers, via an API, to obtain a geolocation of a meeting participant; and changing the scheduling information based on the geolocation. In some implementations, the operations further include receiving an update indicating a meeting participant will miss the in-person meeting; and changing the scheduling information to cancel the in-person meeting at the physical location and to arrange a virtual meeting.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by a processing system, an input for scheduling an in-person meeting between meeting participants, wherein the input includes an indication of the meeting participants;
using, by the processing system, a machine learning model to predict preferences of one or more of the meeting participants for attending the in-person meeting, wherein the preferences include a physical location and an availability, and wherein the machine learning model is trained using historical information including a past physical location and a past availability of the one or more meeting participants;
determining, by the processing system, scheduling information for the in-person meeting based on the input and the preferences, wherein the scheduling information includes a time, a date, and a physical location for the in-person meeting; and
transmitting, by the processing system, the scheduling information to a meeting participant.

2. The method of claim 1, further comprising:
communicating, by the processing system, with one or more servers to obtain traffic information, weather information, and calendar information for a meeting participant;
predicting, by the processing system, movement of the meeting participant based on the traffic information, the weather information, and the calendar information; and
determining, by the processing system, the scheduling information based on the movement.

3. The method of claim 1, further comprising:
communicating, by the processing system, with one or more servers, via an application programming interface (API), to reserve the physical location in accordance with the time and the date for the in-person meeting.

4. The method of claim 1, further comprising:
communicating, by the processing system, with one or more servers, via an API, to obtain a geolocation of a meeting participant; and
changing, by the processing system, the scheduling information based on the geolocation.

5. The method of claim 1, further comprising:
receiving, by the processing system, an update indicating a meeting participant will miss the in-person meeting; and
changing, by the processing system, the scheduling information to cancel the in-person meeting at the physical location and to arrange a virtual meeting.

6. The method of claim 1, further comprising:
receiving, by the processing system, an update indicating a meeting participant will miss the in-person meeting;
changing, by the processing system, the scheduling information based on the update; and
sending, by the processing system, a push notification, to the meeting participant, including the scheduling information with the change based on the update.

7. The method of claim 1, further comprising:
receiving, by the processing system, feedback from a meeting participant; and
building, by the processing system, a behavior tree based on the feedback, wherein the behavior tree is used by the machine learning model to determine other scheduling information for a second in-person meeting.

8. The method of claim 1, wherein the input further includes an indication of equipment for the in-person meeting, a duration for the in-person meeting, and at least one of a date window or a time window for the in-person meeting.

9. An apparatus, comprising:
a memory; and
a processor configured to execute instructions stored in the memory to:
receive an input for scheduling an in-person meeting between meeting participants, wherein the input includes an indication of the meeting participants;
use a machine learning model to predict preferences of one or more of the meeting participants for attending the in-person meeting, wherein the preferences include a physical location and an availability, and wherein the machine learning model is trained using historical information including a past physical location and a past availability of the one or more meeting participants;
determine scheduling information for the in-person meeting based on the input and the preferences, wherein the scheduling information includes a time, a date, and a physical location for the in-person meeting; and
transmit the scheduling information to a meeting participant.

10. The apparatus of claim 9, wherein the processor is further configured to execute instructions stored in the memory to:
communicate with one or more servers to obtain traffic information, weather information, and calendar information for a meeting participant;
predict movement of the meeting participant based on the traffic information, the weather information, and the calendar information; and
determine the scheduling information based on the movement.

11. The apparatus of claim 9, wherein the processor is further configured to execute instructions stored in the memory to:
communicate with one or more servers, via an API, to reserve the physical location in accordance with the time and the date for the in-person meeting.

12. The apparatus of claim 9, wherein the processor is further configured to execute instructions stored in the memory to:
communicate with one or more servers, via an API, to obtain a geolocation of a meeting participant; and
change the scheduling information based on the geolocation.

13. The apparatus of claim 9, wherein the processor is further configured to execute instructions stored in the memory to:
receive an update indicating a meeting participant will miss the in-person meeting; and
change the scheduling information to cancel the in-person meeting at the physical location and to arrange a virtual meeting.

14. The apparatus of claim 9, wherein the processor is further configured to execute instructions stored in the memory to:
receive an update indicating a meeting participant will miss the in-person meeting;
change the scheduling information based on the update; and
send a push notification, to the meeting participant, including the change based on the update.

15. The apparatus of claim 9, wherein the processor is further configured to execute instructions stored in the memory to:
receive feedback from a meeting participant; and
build a behavior tree based on the feedback, wherein the behavior tree is used by the machine learning model to determine other scheduling information for a second in-person meeting.

16. A non-transitory computer readable medium storing instructions operable to cause one or more processors to perform operations comprising:
receiving an input for scheduling an in-person meeting between meeting participants, wherein the input includes an indication of the meeting participants;
using a machine learning model to predict preferences of one or more of the meeting participants for attending the in-person meeting, wherein the preferences include a physical location and an availability, and wherein the machine learning model is trained using historical information including a past physical location and a past availability of the one or more meeting participants;
determining scheduling information for the in-person meeting based on the input and the preferences, wherein the scheduling information includes a time, a date, and a physical location for the in-person meeting; and
transmitting the scheduling information to a meeting participant.

17. The non-transitory computer readable medium storing instructions of claim 16, the operations further comprising:
communicating with one or more servers to obtain traffic information, weather information, and calendar information for a meeting participant;
predicting movement of the meeting participant based on the traffic information, the weather information, and the calendar information; and
determining the scheduling information based on the movement.

18. The non-transitory computer readable medium storing instructions of claim 16, the operations further comprising:
communicating with one or more servers, via an API, to reserve the physical location in accordance with the time and the date for the in-person meeting.

19. The non-transitory computer readable medium storing instructions of claim 16, the operations further comprising:
communicating with one or more servers, via an API, to obtain a geolocation of a meeting participant; and
changing the scheduling information based on the geolocation.

20. The non-transitory computer readable medium storing instructions of claim 16, the operations further comprising:
receiving an update indicating a meeting participant will miss the in-person meeting; and
changing the scheduling information to cancel the in-person meeting at the physical location and to arrange a virtual meeting.
